(19) United States
(12) Patent Application Publication
(10) Pub. No.: US 2025/0337481 A1
(43) Pub. Date: Oct. 30, 2025

(54) MANAGING NETWORK REGISTRATION WITH SATELLITE NETWORKS

(71) Applicant: T-Mobile USA, Inc., Bellevue, WA (US)

(72) Inventors: Ryan P. Dreiling, Shawnee, KS (US); Gregory W. Prestridge, Olathe, KS (US); Zaheer Mohammed Siddique, Overland Park, KS (US)

(21) Appl. No.: 18/646,069

(22) Filed: Apr. 25, 2024

(51) Int. Cl. H04B 7/185; H04W 60/00

(52) U.S. Cl. CPC H04B 7/18519; H04W 60/00

(57) ABSTRACT

A wireless device capable of receiving service from a satellite network. The wireless device receives a signal transmitted by the satellite network, which includes at least one Public Land Mobile Network (PLMN) identifier that is known to the wireless device as one associated with a satellite network. The wireless device enters a Satellite (SAT) mode of operation. The wireless device initially enters a SATELLITE-NOT REGISTERED state of operation, in which it camps on the satellite network in a Radio Resource Control_Idle (RRC_Idle) mode of operation. Then, in response to a user action to obtain service from the satellite network, the wireless device enters a SATELLITE-REGISTERED state of operation, in which it initiates a network Attach procedure with the satellite network and camps on the satellite network in a network Attached state of operation.

### BACKGROUND

Non-terrestrial networks (NTNs) are networks or segments of networks that use airborne or spaceborne vehicles for transmission. These networks use satellites, drones, and other airborne vehicles to provide connectivity wirelessly to even the most remote areas on Earth. This technology has the potential to revolutionize many industries, from agriculture to shipping, by providing reliable, high-speed connectivity to previously unreachable areas. NTN systems can help deliver services anywhere and anytime by offering wider area coverage and ensuring service availability, continuity, and scalability. 5G standards established by the 3rd Generation Partnership Project (3GPP) recognize NTNs as a part of the 5G connectivity infrastructure. In NTNs, Low Earth Orbiting (LEO) satellites, Medium Earth Orbiting (MEO) satellites, and Geostationary Earth Orbiting (GEO) satellites, as well as Highly Elliptical Orbiting (HEO) satellites, can be used not just for backhaul but also for access networks.

### BRIEF DESCRIPTION OF THE DRAWINGS

Detailed descriptions of implementations of the present invention will be described and explained through the use of the accompanying drawings.

FIG. 1 is a block diagram that illustrates a wireless communications system that can implement aspects of the present technology.

FIG. 2 is a block diagram that illustrates 5G core network functions (NFs) that can implement aspects of the present technology.

FIG. 3 illustrates an example of a system that can implement aspects of the present technology.

FIG. 4 is a flow diagram that illustrates a method for managing network registration with satellite networks.

FIG. 5 is a block diagram that illustrates an example of a computer system in which at least some operations described herein can be implemented.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

The disclosed technology relates to the management of network registration procedures performed by a wireless device that is capable of receiving service from a non-terrestrial network (NTN) such as a satellite-based telecommunications network. In a default operating mode of the wireless device, the device can connect to terrestrial networks such as those using 2G, 3G, 4G, LTE, 5G, or Wi-Fi technologies. When not connected to any network, the wireless device is configured to periodically scan all frequency bands it supports to find an available network to connect to. When already connected to a network, the wireless device is configured to periodically scan all frequency bands it supports to find a better network to connect to, should any be available. In addition to the aforementioned terrestrial networks, a wireless device capable of connecting to a non-terrestrial network is further configured to periodically scan all frequency bands it supports to find any available non-terrestrial networks, such as satellite networks, to connect to. Upon finding at least one suitable satellite network, the wireless device can be configured to enter a Satellite (SAT) mode.

Satellite networks are severely resource-constrained due to, among other factors, the high cost associated with launching and operating satellites and the limited space and energy resources available onboard a satellite. Thus, while satellite networks can provide coverage to users even in highly remote parts of the world, they have very limited capacity to carry user traffic. As a result, on one hand, it is important to notify a user when satellite connectivity is available. On the other hand, it is also desirable to allow the user to connect to, and use, the satellite network only when no other alternatives are available and it is absolutely necessary for the user to communicate, such as in the case of an emergency. The wireless device is configured to have dedicated settings that allow a user of the device to manage connectivity to the satellite network. The settings allow the wireless device to notify the user regarding the availability of satellite networks, allow the user to manually initiate connectivity to the satellite network, and allow the wireless device to automatically connect or reconnect with the satellite network. The settings allow the wireless device to acquire a signal from the satellite network, to register with the network to receive voice, data, and text messaging service, or to acquire a signal from the satellite network without registering with the network to receive service until the user takes further actions. In addition to satellite networks, the disclosed technology can also support other types of non-terrestrial networks such as those using High Altitude Platform Stations (HAPS), drones and other unmanned aerial vehicles (UAVs), balloons, and aircraft.

In one implementation of the disclosed technology, a satellite network which includes at least one space-based satellite is configured to provide telecommunications service using an LTE standard. In one implementation of the disclosed technology, a satellite network which includes at least one space-based satellite is configured to provide telecommunications service using a 5G standard. The satellite network broadcasts a System Information Block 1 (SIB1) message including at least one Mobile Country Code (MCC) and at least one Mobile Network Code (MNC) which, when combined to form a Public Land Mobile Network (PLMN) identifier, uniquely identify the satellite network. The wireless device is configured to recognize that a particular PLMN, when received from a telecommunications network, identifies that telecommunications network as capable of providing satellite service. The wireless device is further configured, upon identification of a satellite service-capable telecommunications network, to enter a Satellite (SAT) mode of operation of the wireless device. Upon entering SAT mode, the wireless device can operate in one of two operating states: SATELLITE-NOT REGISTERED and SATELLITE-REGISTERED.

Upon entering SAT mode, the wireless device initially operates in SATELLITE-NOT REGISTERED state, wherein the wireless device camps on the satellite network in Radio Resource Control_Idle (RRC_Idle) mode. When the wireless device is camped on a network in RRC_Idle mode, the wireless device can receive and decode messages transmitted by the network. When in SATELLITE-NOT REGISTERED state, the wireless device is further configured to display a persistent notification on a display of the device to inform the user that a satellite network is available for connection. In another implementation, the device can initiate an LTE Attach procedure on an acquired satellite network and register with the network to receive at least one service including, but not limited to, voice, data, or text messaging, thereby entering a SATELLITE-REGISTERED state.

In one implementation, the wireless device can exit SAT mode upon losing a signal acquired from a satellite-based LTE network for a configurable period. The period can be configured by an operator of the network to be any duration between one minute and 24 hours. In one implementation, the duration can be 5 minutes. In another implementation, the wireless device can exit SAT mode upon acquiring any network that does not broadcast a PLMN identifier that is known to the wireless device to be satellite service-capable. In one implementation, a list of satellite service-capable PLMN identifiers can be stored on at least one non-transitory storage medium in the wireless device by an operator of the home telecommunications network of the wireless device. In another implementation, the list of satellite-capable PLMN identifiers can be stored on a subscriber identity module (SIM). The SIM can be removable from the wireless device by the user, or it can be embedded (eSIM) or integrated (iSIM) into the wireless device. The home telecommunications operator network of the wireless device is a telecommunications network which a user of the device subscribes to as a subscriber.

In one implementation, a wireless device that supports satellite service is configured to display at least one satellite roaming settings menu on a display of the device. The settings menu contains at least two user-selectable settings. At least one user-selectable setting is an On/Off toggle for Satellite Roaming. At least one other user-selectable setting is an On/Off toggle for Satellite Auto-Connect. In one implementation, a default selection of the Satellite Roaming setting can be On and a default selection of the Satellite Auto-Connect setting can be Off. This combination of settings allows the wireless device to scan and identify available satellite networks for connection in the background while preventing the user from automatically connecting and receiving service from the satellite network. Thus, the limited resources of the satellite network can be preserved for only necessary or emergency use.

When the Satellite Roaming setting is set to Off, the Satellite Auto-Connect setting is unavailable for selection by the user. The unavailable Satellite Auto-Connect setting can be visibly greyed out to indicate to the user of the wireless device that the setting is unavailable for modification without first setting the Satellite Roaming setting to On. When the Satellite Roaming setting is set to Off, the wireless device operates in the device's default non-satellite operating mode. Similarly, when the device is in SAT mode, either in SATELLITE-REGISTERED or SATELLITE-NOT REGISTERED state, and the Satellite Roaming setting is changed to Off by the user, the device disconnects from the satellite network and exits SAT mode to operate in its default non-satellite operating mode. In the default non-satellite operating mode, the wireless device does not acquire or camp on a satellite network and instead scans all bands and frequencies it supports to find a suitable terrestrial network. In another implementation, when the user switches the Satellite Roaming setting to On and the wireless device is not camped on or registered on a terrestrial telecommunications network, the device initiates a scan of all bands and frequencies it supports to find a satellite network.

In one implementation, when the Satellite Roaming setting is set to On and the Satellite Auto-Connect setting is set to Off, the wireless device can operate in SATELLITE-NOT REGISTERED state upon entering SAT mode. In this state, the wireless device displays a notification on a display of the wireless device informing the user that a satellite network is available for connection and presenting the user an option to connect. In one embodiment, the notification can substantially say, “Messaging over Satellite Service Available. Connect?” In response to the notification, when the user makes an affirmative selection to connect to the satellite network, the wireless device transitions from SATELLITE-NOT REGISTERED to SATELLITE-REGISTERED state.

In one implementation, when the wireless device is in SATELLITE-NOT REGISTERED state and the user initiates a voice call, the wireless device transitions to SATELLITE-REGISTERED state. Similarly, in another implementation, when the wireless device is in SATELLITE-NOT REGISTERED state and the user initiates a text message, the wireless device transitions to SATELLITE-REGISTERED state. In another implementation, upon entering SATELLITE-REGISTERED state and successfully completing an Attach procedure with the satellite network, the wireless device establishes a data bearer with the satellite network. In yet another implementation, upon entering SATELLITE-REGISTERED state, the wireless device blocks all cellular traffic with the exception of any application or service that is allowed by the device's home telecommunications network operator. In yet another implementation, any application of service that is allowed by the device's home telecommunications network operator can be optimized for use in SAT mode.

In one implementation, an NTN in the form of a satellite network is configured to provide telecommunications service using 5G standards. In yet another implementation, an NTN in the form of a satellite network is configured to provide telecommunications service using 6G standards.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail, to avoid unnecessarily obscuring the descriptions of examples.

### Wireless Communications System

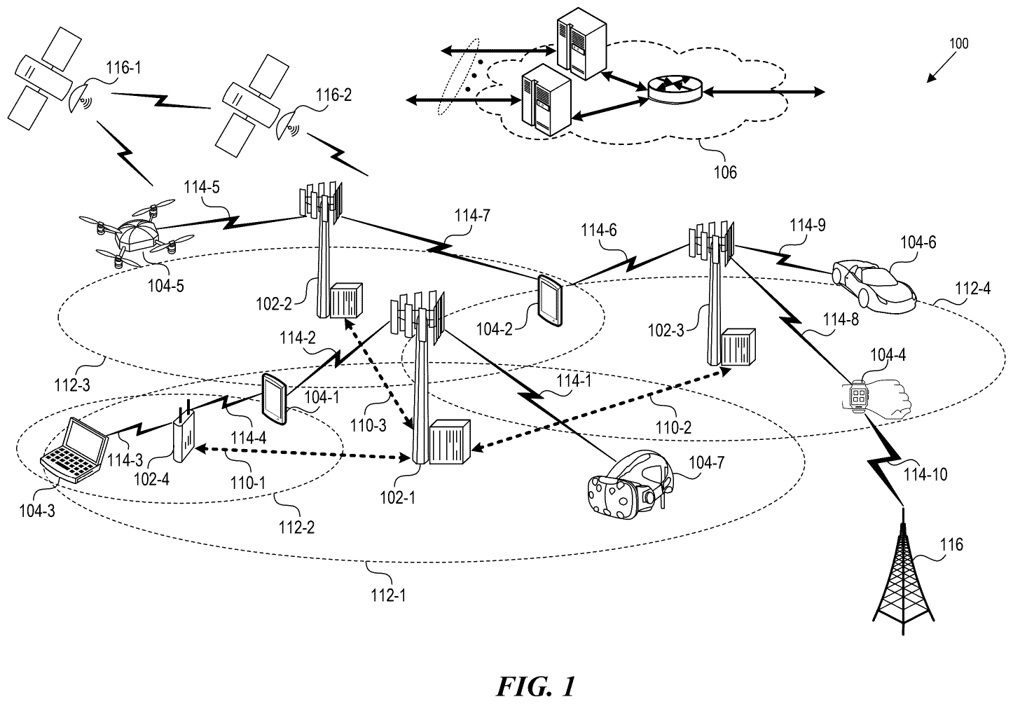

FIG. 1 is a block diagram that illustrates a wireless telecommunication network 100 (“network 100”) in which aspects of the disclosed technology are incorporated. The network 100 includes base stations 102-1 through 102-4 (also referred to individually as “base station 102” or collectively as “base stations 102”). A base station is a type of network access node (NAN) that can also be referred to as a cell site, a base transceiver station, or a radio base station. The network 100 can include any combination of NANs including an access point, radio transceiver, gNodeB (gNB), NodeB, eNodeB (eNB), Home NodeB or Home eNodeB, or the like. In addition to being a wireless wide area network (WWAN) base station, a NAN can be a wireless local area network (WLAN) access point, such as an Institute of Electrical and Electronics Engineers (IEEE) 802.11 access point.

The NANs of a network 100 formed by the network 100 also include wireless devices 104-1 through 104-7 (referred to individually as “wireless device 104” or collectively as “wireless devices 104”) and a core network 106. The wireless devices 104 can correspond to or include network 100 entities capable of communication using various connectivity standards. For example, a 5G communication channel can use millimeter wave (mmW) access frequencies of 28 GHz or more. In some implementations, the wireless device 104 can operatively couple to a base station 102 over a long-term evolution/long-term evolution-advanced (LTE/LTE-A) communication channel, which is referred to as a 4G communication channel.

The core network 106 provides, manages, and controls security services, user authentication, access authorization, tracking, internet protocol (IP) connectivity, and other access, routing, or mobility functions. The base stations 102 interface with the core network 106 through a first set of backhaul links (e.g., S1 interfaces) and can perform radio configuration and scheduling for communication with the wireless devices 104 or can operate under the control of a base station controller (not shown). In some examples, the base stations 102 can communicate with each other, either directly or indirectly (e.g., through the core network 106), over a second set of backhaul links 110-1 through 110-3 (e.g., X1 interfaces), which can be wired or wireless communication links.

The base stations 102 can wirelessly communicate with the wireless devices 104 via one or more base station antennas. The cell sites can provide communication coverage for geographic coverage areas 112-1 through 112-4 (also referred to individually as “coverage area 112” or collectively as “coverage areas 112”). The coverage area 112 for a base station 102 can be divided into sectors making up only a portion of the coverage area (not shown). The network 100 can include base stations of different types (e.g., macro and/or small cell base stations). In some implementations, there can be overlapping coverage areas 112 for different service environments (e.g., Internet of Things (IoT), mobile broadband (MBB), vehicle-to-everything (V2X), machine-to-machine (M2M), machine-to-everything (M2X), ultra-reliable low-latency communication (URLLC), machine-type communication (MTC), etc.).

The network 100 can include a 5G network 100 and/or an LTE/LTE-A or other network. In an LTE/LTE-A network, the term “eNBs” is used to describe the base stations 102, and in 5G new radio (NR) networks, the term “gNBs” is used to describe the base stations 102 that can include mmW communications. The network 100 can thus form a heterogeneous network 100 in which different types of base stations provide coverage for various geographic regions. For example, each base station 102 can provide communication coverage for a macro cell, a small cell, and/or other types of cells. As used herein, the term “cell” can relate to a base station, a carrier or component carrier associated with the base station, or a coverage area (e.g., sector) of a carrier or base station, depending on context.

A macro cell generally covers a relatively large geographic area (e.g., several kilometers in radius) and can allow access by wireless devices that have service subscriptions with a wireless network 100 service provider. As indicated earlier, a small cell is a lower-powered base station, as compared to a macro cell, and can operate in the same or different (e.g., licensed, unlicensed) frequency bands as macro cells. Examples of small cells include pico cells, femto cells, and micro cells. In general, a pico cell can cover a relatively smaller geographic area and can allow unrestricted access by wireless devices that have service subscriptions with the network 100 provider. A femto cell covers a relatively smaller geographic area (e.g., a home) and can provide restricted access by wireless devices having an association with the femto unit (e.g., wireless devices in a closed subscriber group (CSG), wireless devices for users in the home). A base station can support one or multiple (e.g., two, three, four, and the like) cells (e.g., component carriers). All fixed transceivers noted herein that can provide access to the network 100 are NANs, including small cells.

The communication networks that accommodate various disclosed examples can be packet-based networks that operate according to a layered protocol stack. In the user plane, communications at the bearer or Packet Data Convergence Protocol (PDCP) layer can be IP-based. A Radio Link Control (RLC) layer then performs packet segmentation and reassembly to communicate over logical channels. A Medium Access Control (MAC) layer can perform priority handling and multiplexing of logical channels into transport channels. The MAC layer can also use Hybrid ARQ (HARQ) to provide retransmission at the MAC layer, to improve link efficiency. In the control plane, the Radio Resource Control (RRC) protocol layer provides establishment, configuration, and maintenance of an RRC connection between a wireless device 104 and the base stations 102 or core network 106 supporting radio bearers for the user plane data. At the Physical (PHY) layer, the transport channels are mapped to physical channels.

Wireless devices can be integrated with or embedded in other devices. As illustrated, the wireless devices 104 are distributed throughout the network 100, where each wireless device 104 can be stationary or mobile. For example, wireless devices can include handheld mobile devices 104-1 and 104-2 (e.g., smartphones, portable hotspots, tablets, etc.); laptops 104-3; wearables 104-4; drones 104-5; vehicles with wireless connectivity 104-6; head-mounted displays with wireless augmented reality/virtual reality (AR/VR) connectivity 104-7; portable gaming consoles; wireless routers, gateways, modems, and other fixed-wireless access devices; wirelessly connected sensors that provide data to a remote server over a network; IoT devices such as wirelessly connected smart home appliances; etc.

A wireless device (e.g., wireless devices 104) can be referred to as a user equipment (UE), a customer premises equipment (CPE), a mobile station, a subscriber station, a mobile unit, a subscriber unit, a wireless unit, a remote unit, a handheld mobile device, a remote device, a mobile subscriber station, a terminal equipment, an access terminal, a mobile terminal, a wireless terminal, a remote terminal, a handset, a mobile client, a client, or the like.

A wireless device can communicate with various types of base stations and network 100 equipment at the edge of a network 100 including macro eNBs/gNBs, small cell eNBs/gNBs, relay base stations, and the like. A wireless device can also communicate with other wireless devices either within or outside the same coverage area of a base station via device-to-device (D2D) communications.

The communication links 114-1 through 114-9 (also referred to individually as “communication link 114” or collectively as “communication links 114”) shown in network 100 include uplink (UL) transmissions from a wireless device 104 to a base station 102 and/or downlink (DL) transmissions from a base station 102 to a wireless device 104. The downlink transmissions can also be called forward link transmissions while the uplink transmissions can also be called reverse link transmissions. Each communication link 114 includes one or more carriers, where each carrier can be a signal composed of multiple sub-carriers (e.g., waveform signals of different frequencies) modulated according to the various radio technologies. Each modulated signal can be sent on a different sub-carrier and carry control information (e.g., reference signals, control channels), overhead information, user data, etc. The communication links 114 can transmit bidirectional communications using frequency division duplex (FDD) (e.g., using paired spectrum resources) or time division duplex (TDD) operation (e.g., using unpaired spectrum resources). In some implementations, the communication links 114 include LTE and/or mmW communication links.

In some implementations of the network 100, the base stations 102 and/or the wireless devices 104 include multiple antennas for employing antenna diversity schemes to improve communication quality and reliability between base stations 102 and wireless devices 104. Additionally or alternatively, the base stations 102 and/or the wireless devices 104 can employ multiple-input, multiple-output (MIMO) techniques that can take advantage of multi-path environments to transmit multiple spatial layers carrying the same or different coded data.

In some examples, the network 100 implements 6G technologies including increased densification or diversification of network nodes. The network 100 can enable terrestrial and non-terrestrial transmissions. In this context, a non-terrestrial network (NTN) is enabled by one or more satellites, such as satellites 116-1 and 116-2, to deliver services anywhere and anytime and provide coverage in areas that are unreachable by any conventional Terrestrial Network (TN). A 6G implementation of the network 100 can support terahertz (THz) communications. This can support wireless applications that demand ultrahigh quality of service (QOS) requirements and multi-terabits-per-second data transmission in the era of 6G and beyond, such as terabit-per-second backhaul systems, ultra-high-definition content streaming among mobile devices, AR/VR, and wireless high-bandwidth secure communications. In another example of 6G, the network 100 can implement a converged Radio Access Network (RAN) and Core architecture to achieve Control and User Plane Separation (CUPS) and achieve extremely low user plane latency. In yet another example of 6G, the network 100 can implement a converged Wi-Fi and Core architecture to increase and improve indoor coverage.

### 5G Core Network Functions

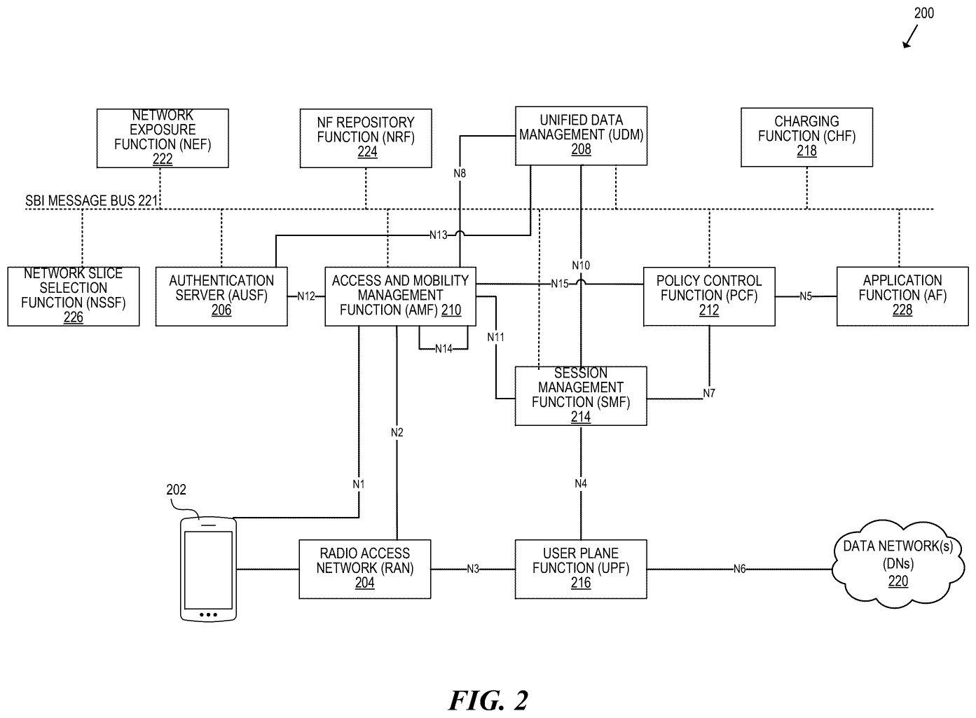

FIG. 2 is a block diagram that illustrates an architecture 200 including 5G core network functions (NFs) that can implement aspects of the present technology. A wireless device 202 can access the 5G network through a NAN (e.g., gNB) of a RAN 204. The NFs include an Authentication Server Function (AUSF) 206, a Unified Data Management (UDM) 208, an Access and Mobility management Function (AMF) 210, a Policy Control Function (PCF) 212, a Session Management Function (SMF) 214, a User Plane Function (UPF) 216, and a Charging Function (CHF) 218.

The interfaces N1 through N15 define communications and/or protocols between each NF as described in relevant standards. The UPF 216 is part of the user plane and the AMF 210, SMF 214, PCF 212, AUSF 206, and UDM 208 are part of the control plane. One or more UPFs can connect with one or more data networks (DNS) 220. The UPF 216 can be deployed separately from control plane functions. The NFs of the control plane are modularized such that they can be scaled independently. As shown, each NF service exposes its functionality in a Service Based Architecture (SBA) through a Service Based Interface (SBI) 221 that uses HTTP/2. The SBA can include a Network Exposure Function (NEF) 222, an NF Repository Function (NRF) 224, a Network Slice Selection Function (NSSF) 226, and other functions such as a Service Communication Proxy (SCP).

The SBA can provide a complete service mesh with service discovery, load balancing, encryption, authentication, and authorization for interservice communications. The SBA employs a centralized discovery framework that leverages the NRF 224, which maintains a record of available NF instances and supported services. The NRF 224 allows other NF instances to subscribe and be notified of registrations from NF instances of a given type. The NRF 224 supports service discovery by receipt of discovery requests from NF instances and, in response, details which NF instances support specific services.

The NSSF 226 enables network slicing, which is a capability of 5G to bring a high degree of deployment flexibility and efficient resource utilization when deploying diverse network services and applications. A logical end-to-end (E2E) network slice has pre-determined capabilities, traffic characteristics, and service-level agreements and includes the virtualized resources required to service the needs of a Mobile Virtual Network Operator (MVNO) or group of subscribers, including a dedicated UPF, SMF, and PCF. The wireless device 202 is associated with one or more network slices, which all use the same AMF. A Single Network Slice Selection Assistance Information (S-NSSAI) function operates to identify a network slice. Slice selection is triggered by the AMF, which receives a wireless device registration request. In response, the AMF retrieves permitted network slices from the UDM 208 and then requests an appropriate network slice of the NSSF 226.

The UDM 208 introduces a User Data Convergence (UDC) that separates a User Data Repository (UDR) for storing and managing subscriber information. As such, the UDM 208 can employ the UDC under 3GPP TS 22.101 to support a layered architecture that separates user data from application logic. The UDM 208 can include a stateful message store to hold information in local memory or can be stateless and store information externally in a database of the UDR. The stored data can include profile data for subscribers and/or other data that can be used for authentication purposes. Given a large number of wireless devices that can connect to a 5G network, the UDM 208 can contain voluminous amounts of data that is accessed for authentication. Thus, the UDM 208 is analogous to a Home Subscriber Server (HSS) and can provide authentication credentials while being employed by the AMF 210 and SMF 214 to retrieve subscriber data and context.

The PCF 212 can connect with one or more Application Functions (AFs) 228. The PCF 212 supports a unified policy framework within the 5G infrastructure for governing network behavior. The PCF 212 accesses the subscription information required to make policy decisions from the UDM 208 and then provides the appropriate policy rules to the control plane functions so that they can enforce them. The SCP (not shown) provides a highly distributed multi-access edge compute cloud environment and a single point of entry for a cluster of NFs once they have been successfully discovered by the NRF 224. This allows the SCP to become the delegated discovery point in a datacenter, offloading the NRF 224 from distributed service meshes that make up a network operator's infrastructure. Together with the NRF 224, the SCP forms the hierarchical 5G service mesh.

The AMF 210 receives requests and handles connection and mobility management while forwarding session management requirements over the N11 interface to the SMF 214. The AMF 210 determines that the SMF 214 is best suited to handle the connection request by querying the NRF 224. That interface and the N11 interface between the AMF 210 and the SMF 214 assigned by the NRF 224 use the SBI 221. During session establishment or modification, the SMF 214 also interacts with the PCF 212 over the N7 interface and the subscriber profile information stored within the UDM 208. Employing the SBI 221, the PCF 212 provides the foundation of the policy framework that, along with the more typical QoS and charging rules, includes network slice selection, which is regulated by the NSSF 226.

Managing Network Registration with Satellite Networks

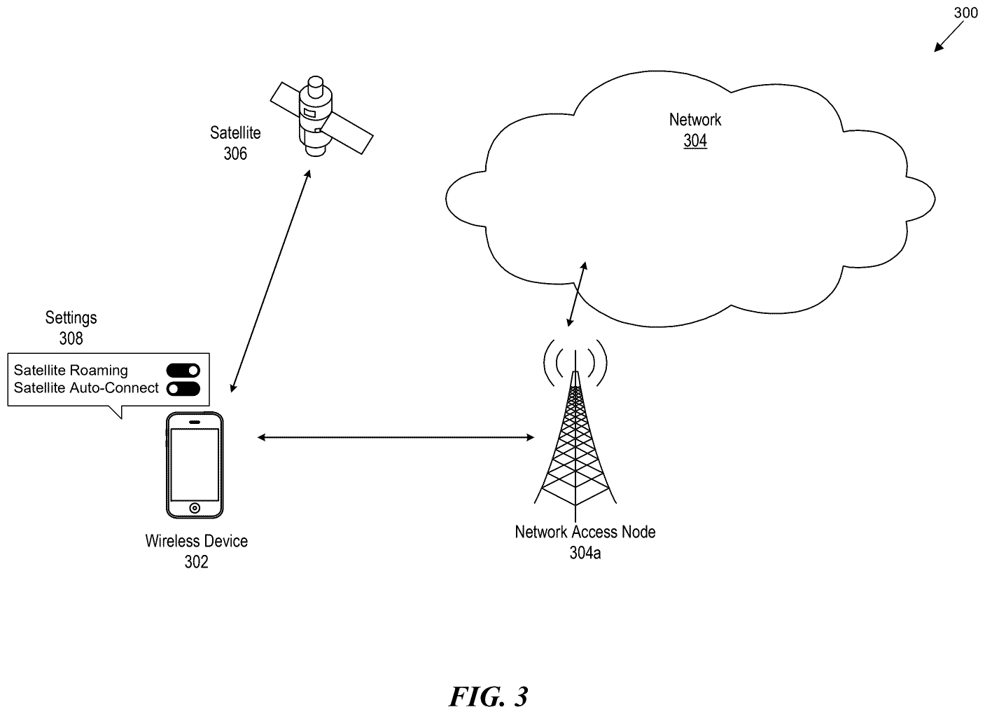

FIG. 3 illustrates an example of a system 300 that can implement aspects of the present technology. The network 304 is a terrestrial telecommunications network to which wireless device 302 connects in a normal mode of operation of the wireless device 302. Network Access Node 304a is a representative network element that is included in the network 304. Satellite 306 is a representative space-based network element of a non-terrestrial network such as a satellite network. When some aspects of the disclosed technology are implemented, the wireless device 302 is configured to identify availability of the satellite network and present various options to a user of the wireless device 302 to receive service from the satellite network. The wireless device 302 can present at least two satellite service-related settings 308 to the user. One of the satellite service-related settings 308 is an On/Off toggle for Satellite Roaming. Another of the satellite service-related settings 308 is an On/Off toggle for Satellite Auto-Connect.

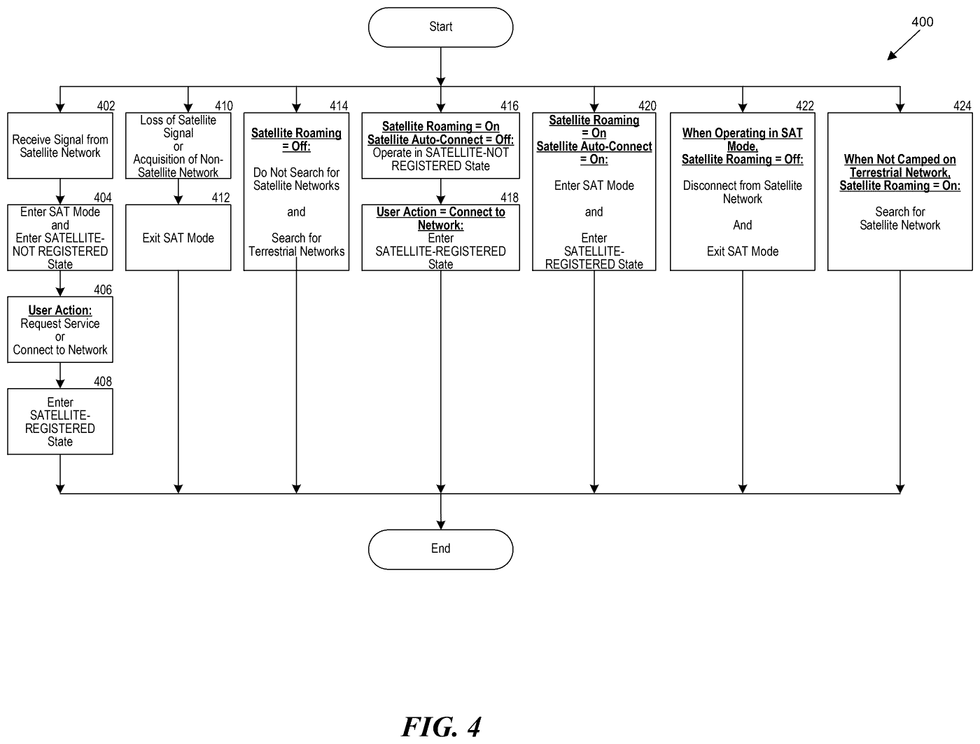

FIG. 4 is a flow diagram that illustrates a method 400 for managing a network registration procedure of a wireless device with a satellite network. The wireless device is capable of receiving service from the satellite network comprising at least one space-based satellite. The wireless device comprises at least one hardware processor, at least one display screen, and at least one non-transitory memory storing instructions, which, when executed by the at least one hardware processor, cause the wireless device to implement the method 400.

At 402, the wireless device receives a signal transmitted by the satellite network. The signal transmitted by the satellite network includes at least one Public Land Mobile Network (PLMN) identifier comprising a Mobile Country Code (MCC) and a Mobile Network Code (MNC). The PLMN identifier is known to the wireless device as one associated with a satellite network. At 404, in response to receiving the signal from the satellite network, the wireless device enters a Satellite (SAT) mode of operation. Entering the SAT mode of operation comprises initially entering a SATELLITE-NOT REGISTERED state of operation, which further comprises camping on the satellite network in a Radio Resource Control_Idle (RRC_Idle) mode of operation.

At 408, upon entering the SAT mode of operation and in response to a user of the wireless device taking an action 406 on the wireless device to obtain service from the satellite network, the wireless device further enters a SATELLITE-REGISTERED state of operation. Entering the SATELLITE-REGISTERED state of operation includes causing the wireless device to initiate a network Attach procedure with the satellite network and camping on the satellite network in a network Attached state of operation. The action 406 taken by the user includes the user affirmatively selecting an option on the at least one display screen of the wireless device to connect to the satellite network, the user initiating a voice call, the user initiating a text message, or the user initiating a data request. The wireless device presents to the user at least two satellite service-related settings on the at least one display screen of the wireless device. The at least two satellite service-related settings comprise a first satellite service-related setting including an On/Off toggle for Satellite Roaming, and a second satellite service-related setting including an On/Off toggle for Satellite Auto-Connect. When the On/Off toggle for Satellite Roaming is set to Off, the On/Off toggle for Satellite Auto-Connect is unavailable to the user for selection. In some implementations, the wireless device can operate in a default configuration in which the first satellite service-related setting including the On/Off toggle for Satellite Roaming is configured to be On, and the second satellite service-related setting including the On/Off toggle for Satellite Auto-Connect is configured to be Off.

At 412, the wireless device exits the SAT mode of operation upon an occurrence of a service-impacting event 410. Occurrence of a service-impacting event comprises the wireless device losing the signal from the satellite network for a duration greater than a configurable threshold, or the wireless device acquiring a signal from another telecommunications network which does not transmit a PLMN identifier known to the wireless device as one associated with a satellite network. The configurable threshold can be configured by a home operator of a telecommunications network of the wireless device to be any value between one minute and 24 hours, both inclusive. In some implementations, the threshold can be 5 minutes.

At 414, the wireless device, in response to the On/Off toggle for Satellite Roaming being set to Off, disables a configuration of the wireless device to search for an available satellite network, and enables a configuration of the wireless device to scan across at least one frequency band supported by the wireless device to search for an available terrestrial telecommunications network. At 416, the wireless device, in response to the On/Off toggle for Satellite Roaming being set to On and the On/Off toggle for Satellite Auto-Connect being set to Off, operates in a SATELLITE-NOT REGISTERED state of operation upon entering the SAT mode of operation. At 418, the wireless device, in response to the user affirmatively selecting to receive the satellite service in response to the wireless device displaying a persistent notification indicating to the user that a satellite service is available, enters a SATELLITE-REGISTERED state of operation. Operating in the SATELLITE-NOT REGISTERED state of operation further comprises causing a display on the at least one display screen of the wireless device of the persistent notification. Entering the SATELLITE-REGISTERED state of operation includes causing the wireless device to initiate a network Attach procedure with the satellite network and camping on the satellite network in a network Attached state of operation. Optionally in some implementations, the wireless device, in response to entering the SATELLITE-REGISTERED state of operation, initiates a network Attach procedure to establish at least one data bearer with the satellite network, and enables a configuration of the wireless device to only allow communication associated with an application or a service that is either approved for use in SAT mode of operation by an operator of a home telecommunications network of the wireless device, or optimized for use in the SAT mode of operation, or both.

At 420, the wireless device, in response to the On/Off toggle for Satellite Roaming being set to On and the On/Off toggle for Satellite Auto-Connect being set to On, enters the SATELLITE-REGISTERED state of operation upon entering SAT mode of operation. At 422, the wireless device, in response to the On/Off toggle for Satellite Roaming being set to Off when the wireless device is operating in SAT mode, disconnects from the satellite network, and stops operating in the SAT mode of operation. At 424, the wireless device, in response to the On/Off toggle for Satellite Roaming being set to On when the wireless device is not camped on any terrestrial telecommunications network, enables a configuration of the wireless device to scan across at least one frequency band supported by the wireless device to search for an available satellite network.

### Computer System

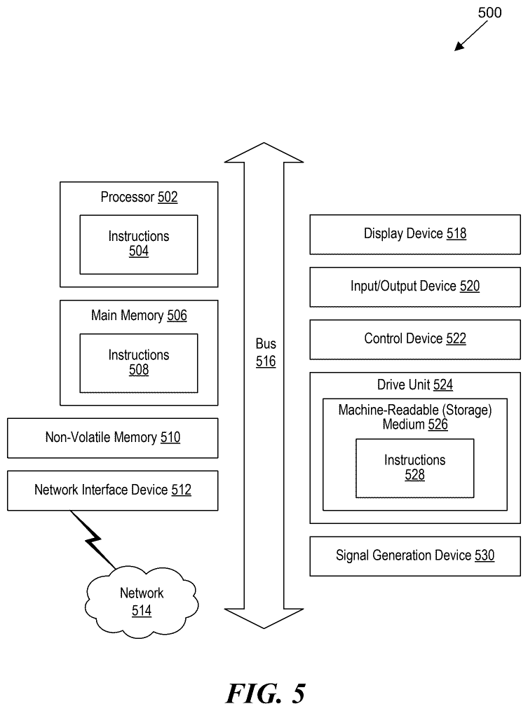

FIG. 5 is a block diagram that illustrates an example of a computer system 500 in which at least some operations described herein can be implemented. As shown, the computer system 500 can include: one or more processors 502, main memory 506, non-volatile memory 510, a network interface device 512, a video display device 518, an input/output device 520, a control device 522 (e.g., keyboard and pointing device), a drive unit 524 that includes a machine-readable (storage) medium 526, and a signal generation device 530 that are communicatively connected to a bus 516. The bus 516 represents one or more physical buses and/or point-to-point connections that are connected by appropriate bridges, adapters, or controllers. Various common components (e.g., cache memory) are omitted from FIG. 5 for brevity. Instead, the computer system 500 is intended to illustrate a hardware device on which components illustrated or described relative to the examples of the figures and any other components described in this specification can be implemented.

The computer system 500 can take any suitable physical form. For example, the computing system 500 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computing system 500. In some implementations, the computer system 500 can be an embedded computer system, a system-on-chip (SOC), a single-board computer system (SBC), or a distributed system such as a mesh of computer systems, or it can include one or more cloud components in one or more networks. Where appropriate, one or more computer systems 500 can perform operations in real time, in near real time, or in batch mode.

The network interface device 512 enables the computing system 500 to mediate data in a network 514 with an entity that is external to the computing system 500 through any communication protocol supported by the computing system 500 and the external entity. Examples of the network interface device 512 include a network adapter card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 506, non-volatile memory 510, machine-readable medium 526) can be local, remote, or distributed. Although shown as a single medium, the machine-readable medium 526 can include multiple media (e.g., a centralized/distributed database and/or associated caches and servers) that store one or more sets of instructions 528. The machine-readable medium 526 can include any medium that is capable of storing, encoding, or carrying a set of instructions for execution by the computing system 500. The machine-readable medium 526 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory 510, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 504, 508, 528) set at various times in various memory and storage devices in computing device(s). When read and executed by the processor 502, the instruction(s) cause the computing system 500 to perform operations to execute elements involving the various aspects of the disclosure.

### Remarks

The terms “example,” “embodiment,” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not for other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense—that is to say, in the sense of “including, but not limited to.” As used herein, the terms “connected,” “coupled,” and any variants thereof mean any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number may also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms either in this application or in a continuing application.

I/We claim:

1. A wireless device capable of receiving service from a satellite network comprising at least one space-based satellite, the wireless device comprising:
at least one hardware processor;
at least one display screen; and
at least one non-transitory memory storing instructions, which, when executed by the at least one hardware processor, cause the wireless device to:
receive a signal transmitted by the satellite network,
wherein the signal transmitted by the satellite network includes at least one Public Land Mobile Network (PLMN) identifier comprising a Mobile Country Code (MCC) and a Mobile Network Code (MNC),
wherein the PLMN identifier is known to the wireless device as one associated with a satellite network; and
in response to receiving the signal from the satellite network, enter a Satellite (SAT) mode of operation,
wherein entering the SAT mode of operation comprises initially entering a SATELLITE-NOT REGISTERED state of operation, and
wherein entering the SATELLITE-NOT REGISTERED state of operation further comprises camping on the satellite network in a Radio Resource Control_Idle (RRC_Idle) mode of operation.

2. The wireless device of claim 1 caused to, upon entering the SAT mode of operation:
in response to a user of the wireless device taking an action on the wireless device to obtain service from the satellite network, enter a SATELLITE-REGISTERED state of operation,
wherein the action taken by the user includes the user affirmatively selecting an option on the at least one display screen of the wireless device to connect to the satellite network, the user initiating a voice call, the user initiating a text message, or the user initiating a data request, and
wherein entering the SATELLITE-REGISTERED state of operation includes causing the wireless device to initiate a network Attach procedure with the satellite network and camping on the satellite network in a network Attached state of operation.

3. The wireless device of claim 1 caused to exit the SAT mode of operation upon an occurrence of a service-impacting event, wherein the occurrence of the service-impacting event comprises:
the wireless device losing the signal from the satellite network for a duration greater than a configurable threshold,
wherein the configurable threshold is configured by a home operator of a telecommunications network of the wireless device to be any value between one minute and 24 hours, both inclusive; or
the wireless device acquiring a signal from another telecommunications network which does not transmit a PLMN identifier known to the wireless device as one associated with a satellite network.

4. The wireless device of claim 1 caused to present to a user of the wireless device at least two satellite service-related settings on the at least one display screen of the wireless device, the at least two satellite service-related settings comprising:
a first satellite service-related setting including an On/Off toggle for Satellite Roaming; and
a second satellite service-related setting including an On/Off toggle for Satellite Auto-Connect,
wherein, when the On/Off toggle for Satellite Roaming is set to Off, the On/Off toggle for Satellite Auto-Connect is unavailable to the user for selection.

5. The wireless device of claim 4 further caused to operate in a default configuration comprising:
the first satellite service-related setting including the On/Off toggle for Satellite Roaming configured to be On; and
the second satellite service-related setting including the On/Off toggle for Satellite Auto-Connect configured to be Off.

6. The wireless device of claim 4 further caused to, in response to the On/Off toggle for Satellite Roaming being set to Off:
disable a configuration of the wireless device to search for an available satellite network; and
enable a configuration of the wireless device to scan across at least one frequency band supported by the wireless device to search for an available terrestrial telecommunications network.

7. The wireless device of claim 4 further caused to, in response to the On/Off toggle for Satellite Roaming being set to On and the On/Off toggle for Satellite Auto-Connect being set to Off:
operate in a SATELLITE-NOT REGISTERED state of operation upon entering the SAT mode of operation,
wherein operating in the SATELLITE-NOT REGISTERED state of operation further comprises causing a display on the at least one display screen of the wireless device of a persistent notification indicating to the user that a satellite service is available; and
in response to the user affirmatively selecting to receive the satellite service in response to the wireless device displaying the persistent notification, enter a SATELLITE-REGISTERED state of operation,
wherein entering the SATELLITE-REGISTERED state of operation includes causing the wireless device to initiate a network Attach procedure with the satellite network and camping on the satellite network in a network Attached state of operation.

8. The wireless device of claim 4 further caused to, in response to the On/Off toggle for Satellite Roaming being set to On and the On/Off toggle for Satellite Auto-Connect being set to On:
enter a SATELLITE-REGISTERED state of operation upon entering the SAT mode of operation,
wherein entering the SATELLITE-REGISTERED state of operation includes causing the wireless device to initiate a network Attach procedure with the satellite network and camping on the satellite network in a network Attached state of operation.

9. The wireless device of claim 4 further caused to, in response to the On/Off toggle for Satellite Roaming being set to Off when the wireless device is operating in the SAT mode of operation:
disconnect from the satellite network; and
stop operating in the SAT mode of operation.

10. The wireless device of claim 4 further caused to, in response to the On/Off toggle for Satellite Roaming being set to On when the wireless device is not camped on any terrestrial telecommunications network:
enable a configuration of the wireless device to scan across at least one frequency band supported by the wireless device to search for an available satellite network.

11. The wireless device of claim 2, further caused to, in response to entering the SATELLITE-REGISTERED state of operation:
initiate a network Attach procedure to establish at least one data bearer with the satellite network; and
enable a configuration of the wireless device to only allow communication associated with an application or a service that is either approved for use in the SAT mode of operation by an operator of a home telecommunications network of the wireless device, or optimized for use in the SAT mode of operation, or both.

12. A non-transitory, computer-readable storage medium comprising instructions recorded thereon, wherein the instructions, when executed by at least one data processor of a system, cause the system to:
receive, at a wireless device capable of receiving service from a satellite network comprising at least one space-based satellite, a signal transmitted by the satellite network,
wherein the wireless device includes at least one hardware processor and at least one display screen,
wherein the signal transmitted by the satellite network includes at least one Public Land Mobile Network (PLMN) identifier comprising a Mobile Country Code (MCC) and a Mobile Network Code (MNC), and
wherein the PLMN identifier is known to the wireless device as one associated with a satellite network; and
in response to receiving the signal from the satellite network, enter a Satellite (SAT) mode of operation,
wherein entering the SAT mode of operation comprises initially entering a SATELLITE-NOT REGISTERED state of operation,
wherein entering the SATELLITE-NOT REGISTERED state of operation further comprises camping on the satellite network in a Radio Resource Control_Idle (RRC_Idle) mode of operation.

13. The non-transitory, computer-readable storage medium of claim 12, wherein the wireless device, upon entering the SAT mode of operation, is further caused to:
in response to a user of the wireless device taking an action on the wireless device to obtain service from the satellite network, enter a SATELLITE-REGISTERED state of operation,
wherein the action taken by the user includes the user affirmatively selecting an option on the at least one display screen of the wireless device to connect to the satellite network, the user initiating a voice call, the user initiating a text message, or the user initiating a data request, and
wherein entering the SATELLITE-REGISTERED state of operation includes causing the wireless device to initiate a network Attach procedure with the satellite network and camping on the satellite network in a network Attached state of operation.

14. The non-transitory, computer-readable storage medium of claim 12, wherein the wireless device is caused to exit the SAT mode of operation upon an occurrence of a service-impacting event, the service-impacting event comprising:
the wireless device losing the signal from the satellite network for a duration greater than a configurable threshold,
wherein the configurable threshold is configured by a home operator of a telecommunications network of the wireless device to be any value between one minute and 24 hours, both inclusive; or
the wireless device acquiring a signal from another telecommunications network which does not transmit a PLMN identifier known to the wireless device as one associated with a satellite network.

15. The non-transitory, computer-readable storage medium of claim 13, wherein the wireless device is caused to present to a user of the wireless device at least two satellite service-related settings on the at least one display screen of the wireless device, the at least two service-related settings comprising:
a first satellite service-related setting including an On/Off toggle for Satellite Roaming; and
a second satellite service-related setting including an On/Off toggle for Satellite Auto-Connect,
wherein, when the On/Off toggle for Satellite Roaming is set to Off, the On/Off toggle for Satellite Auto-Connect is unavailable to the user for selection.

16. The non-transitory, computer-readable storage medium of claim 15, wherein the wireless device is further caused to:
in response to the On/Off toggle for Satellite Roaming being set to Off, disable a configuration of the wireless device to search for an available satellite network, and enable a configuration of the wireless device to scan across at least one frequency band supported by the wireless device to search for an available terrestrial telecommunications network; or
in response to the On/Off toggle for Satellite Roaming being set to On when the wireless device is not camped on any terrestrial telecommunications network, enable a configuration of the wireless device to scan across at least one frequency band supported by the wireless device to search for an available satellite network.

17. The non-transitory, computer-readable storage medium of claim 15, wherein the wireless device is further caused to:
in response to the On/Off toggle for Satellite Roaming being set to On and the On/Off toggle for Satellite Auto-Connect being set to On, enter a SATELLITE-REGISTERED state of operation upon entering the SAT mode of operation,
wherein entering the SATELLITE-REGISTERED state of operation includes causing the wireless device to initiate a network Attach procedure with the satellite network and camping on the satellite network in a network Attached state of operation.

18. The non-transitory, computer-readable storage medium of claim 15, wherein the wireless device is further caused to:
in response to entering the SATELLITE-REGISTERED state of operation, initiate a network Attach procedure to establish at least one data bearer with the satellite network; and
enable a configuration of the wireless device to only allow communication associated with an application or a service that is either approved for use in the SAT mode of operation by an operator of a home telecommunications network of the wireless device, or optimized for use in the SAT mode of operation, or both.

19. A method for managing a connection between a wireless device capable of receiving service from a satellite network and a satellite network comprising at least one space-based satellite, the method comprising the wireless device:
receiving a signal transmitted by the satellite network,
wherein the signal transmitted by the satellite network includes at least one Public Land Mobile Network (PLMN) identifier comprising a Mobile Country Code (MCC) and a Mobile Network Code (MNC) that is known to the wireless device as one associated with a satellite network; and
in response to receiving the signal from the satellite network, entering a Satellite (SAT) mode of operation,
wherein entering the SAT mode of operation comprises initially entering a SATELLITE-NOT REGISTERED state of operation, and
wherein entering the SATELLITE-NOT REGISTERED state of operation further comprises camping on the satellite network in a Radio Resource Control_Idle (RRC_Idle) mode of operation.

20. The method of claim 19 further comprising the wireless device, upon entering the SAT mode of operation:
in response to a user of the wireless device taking an action on the wireless device to obtain service from the satellite network, entering a SATELLITE-REGISTERED state of operation,
wherein the action taken by the user includes the user affirmatively selecting an option on at least one display screen of the wireless device to connect to the satellite network, the user initiating a voice call, the user initiating a text message, or the user initiating a data request, and
wherein entering the SATELLITE-REGISTERED state of operation includes causing the wireless device to initiate a network Attach procedure with the satellite network and camping on the satellite network in a network Attached state of operation.
